(19) United States
(12) Patent Application Publication
(10) Pub. No.: US 2020/0100491 A1
(43) Pub. Date: Apr. 2, 2020

(54) Inactivation of Insects With Light

(71) Applicant: Vital Vio, Inc., Troy, NY (US)

(72) Inventors: Cori Winslow, Rensselaer, NY (US); Robert Barron, Port Washington, NY (US); Aram Kuzmak, Troy, NY (US); Sara Shelley, Albany, NY (US); Kasia Kozak, Troy, NY (US)

(21) Appl. No.: 16/585,844

(22) Filed: Sep. 27, 2019

Related U.S. Application Data
(60) Provisional application No. 62/738,094, filed on Sep. 28, 2018.

(51) Int. Cl. A01M 1/22

(52) U.S. Cl. CPC A01M 1/226; A01M 2200/012; A01M 1/223

(57) ABSTRACT

Devices, methods, and systems for inactivation of insects with light are disclosed. In some examples, a first lighting source is operable to provide light at wavelength range of about 420 nm-510 nm with an irradiance sufficient to initiate the inactivation of insects. One or more sensors and a control system may be used to control operation of the first lighting source, such as by adjusting the first lighting source in response to various inputs.

### CROSS-REFERENCE TO RELATED APPLICATIONS

This application claims the benefit of U.S. Provisional Application No. 62/738,094, titled “Inactivation of Insects with Light,” and filed on Sep. 28, 2018. The above-referenced application is hereby incorporated by reference in its entirety.

### TECHNICAL FIELD

Aspects of the present disclosure generally relate to processes, systems, and apparatus for inactivating insects using light.

### BACKGROUND

Methods generally used for controlling insects in exterior areas such as applying chemicals, repellants, and the like, may not be suitable for indoor spaces. Some of these methods may also be harmful for humans and animals. Additionally, such methods may not always be effective against insect eggs and/or larvae.

### SUMMARY

The following presents a simplified summary in order to provide a basic understanding of some aspects of the disclosure. The summary may be not an extensive overview of the disclosure. It may be neither intended to identify key or critical elements of the disclosure nor to delineate the scope of the disclosure. The following summary merely presents some concepts of the disclosure in a simplified form as a prelude to the description below.

Methods, devices, and techniques are described herein for providing light to inactivate insects. In some examples, one or more light emitters emit light in a wavelength range of about 420 nm-510 nm to inactivate insects.

An example device may comprise a body, a first light source, a sensor, and a controller. In some examples, the first light source may be disposed within the body and may be operable to provide light comprising a wavelength range of about 420 nm-510 nm and comprising an irradiance sufficient to inactivate insects. In some examples, the sensor may be operable to detect motion. In some examples, the controller may be in communication with the first light source and the sensor, and may be configured to adjust, based on the sensor detecting the motion, an intensity of the light provided by the first light source.

An example method for inactivating insects may comprise causing output of a light from a first light source. The light from the first light source may be output comprising a wavelength range of about 420 nm-510 nm and comprising an irradiance sufficient to inactivate insects. The method may further comprise, detecting, via a sensor, motion, and adjusting, based on the sensor detecting the motion, an intensity of the light from the first light source.

An example system for inactivating insects may comprise a first light source operable to provide light comprising a wavelength range of about 420 nm-510 nm and comprising an irradiance sufficient to inactivate insects. The system may further comprise a sensor that is operable to detect motion. The system may further comprise a controller, in communication with the first light source and the sensor. The controller may be configured to adjust, based on the sensor detecting the motion, an intensity of the light provided by the first light source.

### BRIEF DESCRIPTION OF THE DRAWINGS

FIG. 1 shows an example development stages of an insect, in accordance with one or more examples disclosed herein;

FIGS. 2A-2D show example lighting devices to inactivate insects, in accordance with one or more examples disclosed herein;

FIGS. 3A and 3B show an example lighting device to inactivate insects, in accordance with one or more examples disclosed herein;

FIGS. 4A and 4B show an example lighting device to inactivate insects and for disinfection, in accordance with one or more examples disclosed herein;

FIG. 5 shows an example lighting device to inactivate insects, in accordance with one or more examples disclosed herein;

FIGS. 6A and 6B show example container devices with integrated light sources to inactivate insects, in accordance with one or more examples disclosed herein;

FIGS. 7A and 7B show example container devices with integrated light sources to inactivate insects, in accordance with one or more examples disclosed herein;

FIGS. 8A-8C show an example bowl-shaped container device with integrated light sources to inactivate insects, in accordance with one or more examples disclosed herein;

FIGS. 9A and 9B show an example garbage can with light sources, integrated on a lid, to inactivate insects, in accordance with one or more examples disclosed herein;

FIGS. 10A and 10B shows an example garbage can with light sources, integrated on a lid and in a lower receptacle, to inactivate insects, in accordance with one or more examples disclosed herein;

FIG. 11 shows an example garbage can with an insect trapping mechanism and light sources to inactivate insects, in accordance with one or more examples disclosed herein;

FIGS. 12A and 12B show an example container with integrated light sources to inactivate insects, in accordance with one or more examples disclosed herein;

FIGS. 13A and 13B show an example insect trap with integrated light sources for luring, trapping, and inactivation of insects, in accordance with one or more examples disclosed herein;

FIGS. 14A and 14B show an example task lighting device affixed onto a surface, in accordance with one or more examples disclosed herein;

FIG. 15 shows an example method for insect inactivation using light, in accordance with one or more examples disclosed herein; and

FIG. 16 shows an example computing device, that may be used for generation and/or control of light to inactivate insects, in accordance with one or more examples disclosed herein.

### DETAILED DESCRIPTION

In the following description of the various examples, reference may be made to the accompanying drawings, which form a part hereof, and in which may be shown by way of illustration, various examples of the disclosure that may be practiced. It may be to be understood that other examples may be utilized.

Insect infestation in indoor environments is a common issue. An example insect commonly found in homes is the Drosophila melanogaster, also known as the fruit fly. Insects may be attracted from outside by odors, may hatch from eggs laid on the skin of produce brought into the home, or may enter by other means. Insects may continue to propagate in various conducive environments usually found in indoor spaces (e.g., food receptacles, kitchens, dining areas, or the like).

Repellants, insecticides, traps, etc., are among the several existing solutions to an insect infestation, but these solutions have several drawbacks. Bug zappers, for example, may use bright, unpleasant lighting, cause loud sounds, and create bad odors. As a result, bug zappers are most often limited to outdoor settings. Repellants and insecticides are not suitable for use in proximity with edible items and may often be harmful to humans. Other traps such as, sticky paper, etc., may require frequent maintenance and/or may be aesthetically unappealing. Importantly, many of these solutions also only target an insect in an adult stage and are ineffective for targeting insect eggs, larvae, and pupae.

Various methods, devices, and systems disclosed herein may use different wavelengths of visible light to prevent an insect infestation. Techniques described herein may be used to target insects in different stages of an insect life cycle, including stages prior to an adult stage. Various methods, devices and devices disclosed herein may use visible light inactivation techniques in conjunction with other techniques (e.g., luring and trap mechanisms) to prevent and/or control an insect infestation. Exposing insects to visible light at the wavelengths disclosed herein may inactivate insects by killing, preventing development, reducing productive capabilities, and/or by stunting growth.

As disclosed herein, utilizing visible light to inactivate insects may provide a multitude of advantages over existing solutions. For example, light-based inactivation techniques may be safer than other techniques (e.g., chemical methods, electrocution). Light-based inactivation techniques may be used to target spaces where insects are most likely to occur and reproduce rather than luring them to a device that then inactivates them. Light-based inactivation techniques may require lower maintenance than other techniques. For example, sticky mats may need to be replaced frequently, but light sources for inactivating light require much lower, if at all any, maintenance. Using light to inactivate insects may reduce use of harmful chemicals and effects generally associated with manufacturing these chemicals. The lifetime of a lighting array may be greater than the effective duration of an insecticide. This may result in less waste through reduced manufacturing and disposal processes.

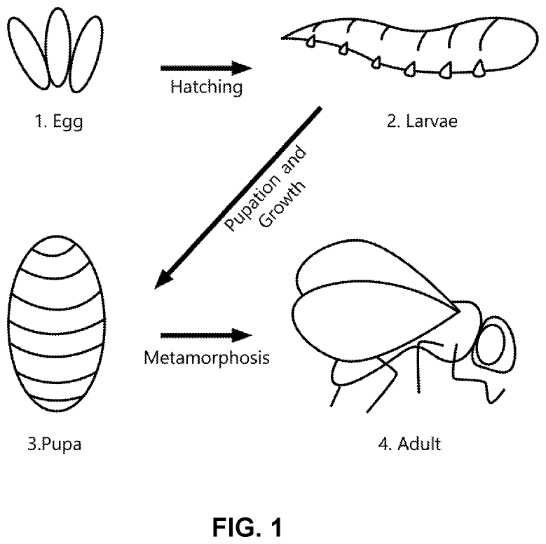

FIG. 1 shows example development stages of an insect. Insects hatch from eggs and may undergo a growth phase in a larval stage. The pupal stage may follow the larval stage. Larvae may undergo metamorphosis and reach the adult stage. Insects in stages prior to adulthood are may be susceptible to particular light wavelengths (e.g., 417 nm, 440 nm, 456 nm, 467 nm. Inactivation of insects in stages prior to an adult stage may prevent an insect infestation and/or eradicate an existing infestation. Some visible light wavelengths may also be effective to control adult insect populations. Some wavelengths of visible light (e.g., blue wavelengths) may also be used to shorten insect lifespans and decrease insect reproductive capabilities drastically, thereby shortening a duration of an existing infestation.

Such wavelengths of light may activate photosensitizers within insects, which may kill the insect. For example, blue light from approximately 430 nm-490 nm (e.g., 440 nm, 467 nm, etc.) may be used to inactivate D. melanogaster. The photosensitizers within the insect may absorb the blue light and stimulate the production of free radicals. The produced free radicals may cause tissue damage within the insect, and the insects may die from that tissue damage. Blue light may be effective on eggs, larvae, pupae, and adult insects as well. If the blue light does not completely inactivate an insect, it may reduce their lifespan and reproduction capabilities, which may drastically reduce the time of infestation in the home. As discussed above, blue light at 467 nm may be effective against D. melanogaster, although different wavelengths of light may be used for different insect species to activate their specific photosensitizers. Additional examples of insects that may be inactivated by visible light include Culex pipiens molestus and Tribolium confusum. C. pipiens molestus, a mosquito, may be inactivated with visible light emitted at approximately 417 nm. T. confusum, also known as the confused flour beetle, may be inactivated with visible light emitted in the range of 400 nm-470 nm (e.g., 404 nm, 417 nm, 456 nm, and 467 nm). Humans, plants, and animals may not be affected by such light because humans, plants, and animals do not contain the same photosensitizers. Accordingly, the lighting methods, system, and apparatuses disclosed herein may be safe for human exposure.

In some examples, a certain dosage, measured in Joules (J), of the blue light may be applied to cause the inactivation of D. melanogaster. For example, D. melanogaster may require a minimum dosage, or radiant exposure, of 0.5 J/m² of 467 nm light. In some examples, a dosage as high as 5.5 J/m² may be required. Dosage may also be defined in terms of irradiance. Equation 1 may be used in order to determine irradiance, dosage, or time:

$$\frac{Irradiance ( \frac{mW}{{cm}^{2}} )}{1000} * Time ( s ) = Dosage ( \frac{J}{{cm}^{2}} ) \qquad Equation 1$$

Table 1 shows example correlations between irradiance, in mW/cm², and dosage, in J/cm², based on different exposure times according to Equation 1. These values are examples and many others may be possible.

TABLE 1
Example correlations between irradiance and dosage

| Irradiance (mW/cm²) | Exposure Time (hours) | Dosage (Joules/cm²) |
|---|---|---|
| 0.02 | 1 | 0.072 |
| 0.02 | 24 | 1.728 |
| 0.02 | 250 | 18 |
| 0.02 | 500 | 36 |
| 0.02 | 1000 | 72 |
| 0.05 | 1 | 0.18 |
| 0.05 | 24 | 4.32 |
| 0.05 | 250 | 45 |
| 0.05 | 500 | 90 |
| 0.05 | 1000 | 180 |
| 0.1 | 1 | 0.36 |
| 0.1 | 24 | 8.64 |
| 0.1 | 250 | 90 |
| 0.1 | 500 | 180 |
| 0.1 | 1000 | 360 |
| 0.5 | 1 | 1.8 |
| 0.5 | 24 | 43.2 |
| 0.5 | 250 | 450 |
| 0.5 | 500 | 900 |
| 0.5 | 1000 | 1800 |
| 1 | 1 | 3.6 |
| 1 | 24 | 86.4 |
| 1 | 250 | 900 |
| 1 | 500 | 1800 |
| 1 | 1000 | 3600 |

A minimum irradiance of 0.05 milliwatts per centimeter squared (mW/cm²) may be required for D. melanogaster. In some examples, an irradiance of 0.55 mW/cm² may be required. Tables 2 and 3 respectively show example effectiveness of 467 nm light of different irradiances on pupae of D. melanogaster.

TABLE 2
Effectiveness of 467 nm light on D. melanogaster

| | | Approx. |
|---|---|---|
| Photon Flux | Irradiance | Effectiveness |
| (photons/m²s) | (mW/cm²) | (% Inactivated) |
| 1.20E+18 | 0.05 | 20% |
| 2.00E+18 | 0.09 | 70% |
| 3.00E+18 | 0.13 | 95% |
| 4.00E+18 | 0.17 | 98% |
| 5.00E+18 | 0.21 | 100% |
| 1.00E+19 | 0.43 | 100% |
| 1.20E+19 | 0.51 | 100% |

TABLE 3
Effectiveness of 440 nm light on D. melanogaster

| | | Approx. |
|---|---|---|
| Photon Flux | Irradiance | Effectiveness |
| (photons/m²s) | (mW/cm²) | (% Inactivated) |
| 1.20E+18 | 0.05 | 18% |
| 2.00E+18 | 0.09 | 73% |
| 3.00E+18 | 0.14 | 98% |
| 4.00E+18 | 0.18 | 100% |
| 5.00E+18 | 0.23 | 100% |
| 1.00E+19 | 0.45 | 100% |
| 1.20E+19 | 0.54 | 100% |

Other wavelengths such as 456 nm, 417 nm, 404 nm, 496 nm, 378 nm, 508 nm (±5 nm) may also be effective at inactivating Drosophila melanogaster. These wavelengths may be effective at higher irradiances (greater than 0.1 mW/cm²) or with larger dosages. Light at 417 nm wavelength may also be used for inactivating Culex pipiens molestus. Light at 404 nm, 417 nm, 456 nm, and 467 nm may be used for inactivating Tribolium confusum. Other light wavelengths may also be used for inactivating different insects.

Various methods, devices, and systems described herein may use, for example, light in a wavelength range of about 420 nm-510 nm to inactivate insects. In various examples described herein, light at a specified wavelength or wavelength range may correspond to light which has a maximum emitted energy/power/energy spectral density/power spectral density approximately at the specified wavelength or within the specified wavelength range, with reasonable variations (e.g., ±5 nm, ±10 nm, etc.).

Various environments (e.g., surfaces, enclosures, containers, etc.) may be subject to inactivating light. Examples environments that may utilize inactivating light include, but are not limited to, food containers (e.g., fruit bowls), mats, cutting boards, garbage cans, insect traps, sinks, kitchen countertops, produce sections (e.g., at a grocery store), kitchen appliances (e.g., refrigerators, ovens), and/or other environments.

In many cases, environments that often harbor insects may also benefit from antimicrobial techniques that kill harmful microorganisms. Wavelengths of visible light in the violet range, 380 nm-420 nm (e.g. 405 nm) may have a lethal effect on microorganisms (e.g., bacteria, yeast, mold, and/or fungi) and may be combined with insect inactivating lighting. Examples of bacteria inactivated by 380 nm-420 nm light are Escherichia coli (E. coli), Salmonella, Methicillin-resistant Staphylococcus aureus (MRSA), and Clostridium Difficile. These wavelengths of light initiate a photoreaction with the porphyrin molecules found in microorganisms. The porphyrin molecules may react with other cellular components to produce Reactive Oxygen Species (ROS). ROS may cause irreparable cell damage and eventually leads to cell death. This same kill mechanism does not work in humans, plants, or animals, because these organisms do not contain the same porphyrin molecules, making this technique completely safe for human exposure. There may be a minimum required dosage to cause microbial inactivation. For example, a minimum irradiance of 0.02 mW/cm² (e.g., on a surface to be disinfected) may be required to cause microbial inactivation over time. The time required to achieve cell death may be inversely proportional to a level of irradiance.

Various methods, devices, and systems described herein may use light sources that are configured to emit light at wavelengths appropriate to inactivate insects. Various methods, devices, and systems described herein may use light sources that are configured to emit light at wavelengths appropriate to inactivate microorganisms.

Examples of light sources may include light emitting diodes (LED), organic LEDs (OLEDs), lasers, semiconductor dies, light converting materials, light converting layers, LEDs with light converting material(s)/layer(s), electroluminescent wires, electroluminescent sheets, flexible LEDs, light emitting layers, etc. A light source may comprise of a single LED package that may include one or more semiconductor emitter dies within the LED package. Example light sources may comprise directional lights (e.g., aimed at a surface/area), puck lights, strip lights. under-cabinet lighting, and/or overhead lighting fixtures, etc.

One or more devices described herein may use a light emitting layer that emits light at desired wavelengths. A light emitting layer may comprise, for example, one or more light sources (e.g., LEDs, light converting layers, etc.). The light emitting layer may be flexible or rigid. The one or more light sources may be, for example, embedded in/attached to a flexible or rigid substrate.

Blue light (e.g., wavelength range of 420 nm-510 nm) and violet light (e.g., wavelength range of 380 nm-420 nm) may be used synergistically to both inactivate insects and harmful microorganisms. Various example methods, devices, and systems described herein may use one or both of blue light and violet light sources.

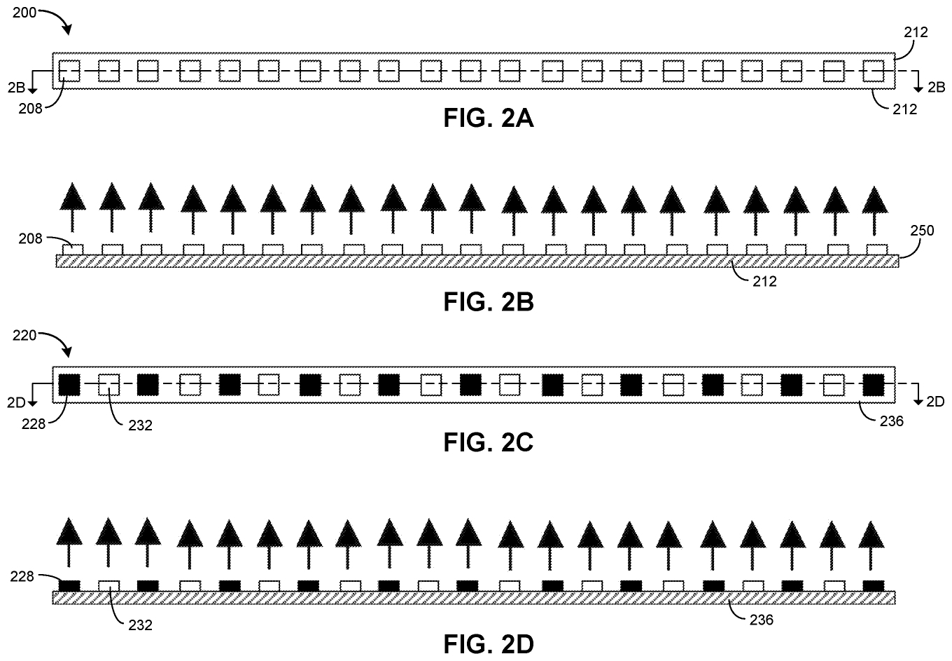

FIGS. 2-14 show various example devices for inactivating insects and/or for disinfection. Arrows show the example general direction of emitted light. The devices may be powered through the use of batteries. If rechargeable batteries are used, the batteries may be recharged, for example, using AC power or solar panels (e.g., if sufficient sunlight is available). Alternatively, the device may be provided with electrical connectors that may be used to connect into external AC power outlets. In one such example, an AC to DC converter and an LED driver may be used to power the devices. In some examples, the devices may be connected to a DC power supply if DC power is available from an external source. Wired power supply may be used, for example, in non-portable products such as door handles or hand railings. Wireless/inductive power supply may also be used (e.g., charge batteries or power lighting devices).

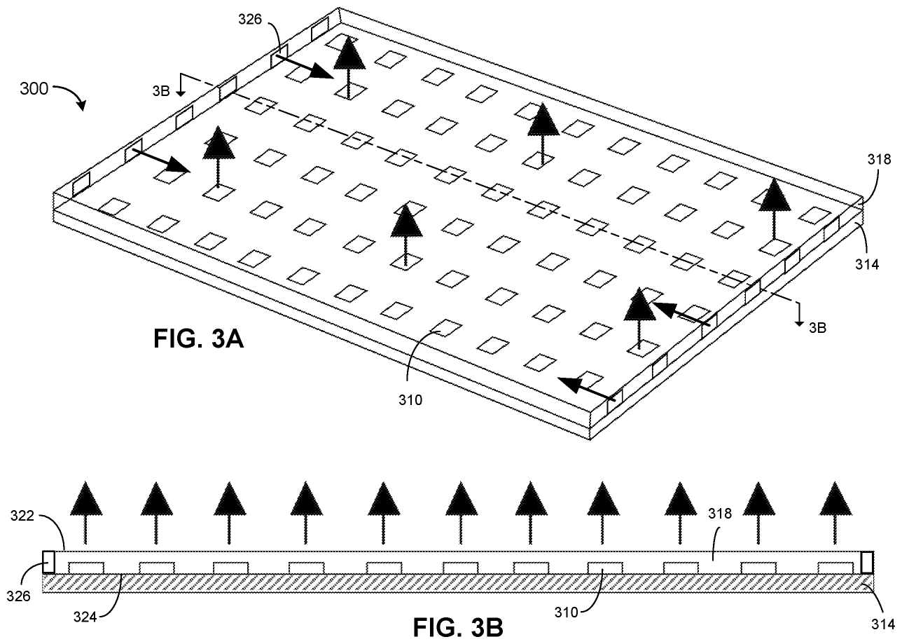

FIGS. 2A-2D show various example lighting devices, in accordance with one or more examples described herein. FIGS. 2A and 2B show a top view and a side view, respectively, of a lighting device 200. The lighting device 200 may correspond to a strip lighting device and may comprise blue light sources 208. The blue light sources 208 may generate light at wavelength(s) or wavelength ranges that are appropriate to inactivate insects. FIGS. 2C and 2D show a top view and a side view, respectively, of a lighting device 220. The lighting device 220 may correspond to a strip lighting device and may comprise blue light sources 228 and violet light sources 232. The blue light sources 228 may generate light at wavelength(s) or wavelength ranges that are appropriate to inactivate insects light, and the violet light sources 232 may generate light at wavelength(s) or wavelength ranges that are appropriate to disinfect. The lighting devices 200 or 220 may be attached to a flexible or rigid PCB. The lighting devices 200 and/or 220 may be used for providing inactivating or disinfecting light in one or more devices described with reference to FIGS. 3-14.

As shown in FIGS. 2A-2D, a lighting device may comprise an array of light sources. Within an array, a first light source and a second light source, that is located nearest to the first light source, may be spaced such that half of a beam angle associated with light emitted by a first light source overlaps (e.g., on a surface at a target location) with half of a beam angle associated with light emitted by a second light source. In some examples, half of the beam angle associated with the first light source (or the second light source) may correspond to a beam angle that results in received power (e.g., on a surface at a target location) to be at least 50% of a maximum power emitted by the first light source (or the second light source). In some examples, half of the beam angle associated with the first light source (or the second light source) may correspond to a beam angle that results in an irradiance (e.g., on a surface at a target location) to be at least 50% of a maximum emission intensity of the first light source (or the second light source).

In some examples, a transparent or translucent layer (hereinafter “TT layer”) may be used with the light sources disclosed herein. The TT layer may comprise, for example glass, plastic, and/or rubber. As used herein, “transparent” or “translucent” may correspond to any level of light transmission short of opaque. TT layers may be flexible or rigid, and may encase the light sources or may be positioned over the light sources. An example light emitting device may be a rigid structure with a rigid TT layer. In some examples, a TT layer may be coupled to a rigid structure that comprises a light emitting layer. In some examples, a TT layer may be positioned over a flexible or a rigid light emitting layer. The TT layer may be, for example, flush to a flexible light emitting layer (e.g., surface to surface). The TT layer may be configured to be a protective layer over the light emitting layer. Other methods of protection may be used (e.g., a conformal coating over the light emitting layer). Light from a light emitting layer may travel through a TT layer and exit an exterior surface of the TT layer, generating an exiting light. In some examples, a portion of the exterior surface may not be transparent or translucent. The lighting devices 200 or 220 may comprise a TT layer over the light emitters.

In some examples, a lighting device may comprise light-converting layer(s) to convert at least a portion of light, emitted from a light source, to wavelength(s) different from the wavelength(s) of light emitted from a light source. In some examples, a light-converting layer may be embedded in a TT layer. In some examples, the light-converting layer may be an additional layer over, under, or embedded in the TT layer. The light-converting layer may be located anywhere along a path of light emitted by the light source. Light-converting layer may include any now known or later developed layer(s) for converting all or certain portion(s) of light spectrum to different wavelengths. In some examples, a light-converting layer may comprise one or more of phosphor, an optical brightener and/or quantum dots. Intensity, color, and, wavelength of exiting light may be customized by use of different methods of light generation (e.g., different types/wavelengths of light sources) and conversion (e.g., different light converting materials).

Light, emitted by a light source, may be converted (e.g., using a light converting layer) to generate inactivating light of another wavelength or inactivating light with a spectrum that is spread across multiple wavelengths (e.g., a white light). For example, light emitted by a light emitting layer may be converted to a white light. The white light may comprise light within a wavelength range of 420 nm-510 nm, and may further comprise light within other wavelength ranges (e.g., 380 nm-420 nm and 550 nm-700 nm). In some examples, lights of different wavelength ranges may be combined to generate white light. For example, 450 nm-500 nm light may be produced using blue phosphors and 550 nm-700 nm light may be produced using nitride phosphors. Other colors of light may also be generated in this manner. Blue pump white light may be based on yellow or green and red phosphors. 490 nm-700+ nm light may be produced using yellow (YAG), green (GAL), or red (nitride) phosphors.

FIG. 3 shows an example lighting device 300 for inactivation of insects, in accordance with one or more examples disclosed herein. The lighting device 300 may be, for example, an internally illuminated mat and/or a cutting board. The lighting device 300 may comprise light sources 310 (e.g., LEDs). In various example, other light emitting devices (e.g., OLED layers, electroluminescent wires, or the like) may be used. The lighting device 300 may further comprise a substrate 314 and a TT layer 318 that is coupled to the substrate 314. The light sources 310 may be, for example, attached to the substrate 314 to form a light emitting layer. In some examples, the light emitting layer may be coupled to an interior surface 324 of the TT layer 318 and may be facing an exterior surface 322 of the TT layer 318. In some examples, an interior surface 324 has a same shape as a shape of the exterior surface 322. In another example, the light sources 310 may be, for example, within the TT layer 318.

At least a portion of light may be in a wavelength range of 420 nm-510 nm. The emitted light may have an irradiance that is sufficient to inactivate insects. The emitted light may illuminate an exterior surface of the TT layer 318 and any items placed thereon. Emitted light may be configured to correspond to any color, as long as the light is at intensities, wavelengths, and irradiances that are appropriate to inactivate insects.

The lighting device 300 may further comprise light converting layer(s) to convert light emitted by the light sources 310. The TT layer 318 may comprise, for example, one or more light converting layers to convert light, as emitted by the lighting elements 310, to a blue light. Light (e.g., emitted by the lighting elements 310) may travel through the TT layer 318 to illuminate the exterior surface 322 of the device 300 (e.g., with a blue light), and cause inactivation of insects on the exterior surface 322, or on items placed on the exterior surface 322.

In some examples, the TT layer 318 may be configured to emit other wavelengths/wavelength ranges of light outside the wavelength range of 420 nm-510 nm, in addition to light in the wavelength range of 420 nm-510 nm. For example, a light converting layer, embedded in the TT layer 318, may be used to generate wavelengths/wavelength ranges of light outside the wavelength range of 420 nm-510 nm.

In some examples, the TT layer 318 may not comprise a light converting layer and may change the wavelength of light. Light exiting the exterior surface 322 of the TT layer 318 may have same wavelengths as light emitted from the light sources 310. In some examples, the light sources 310 may comprise light exclusively in the range of 420 nm-510 nm and the exiting light may comprise light exclusively in the range of 420 nm-510 nm.

An example lighting device may comprise a flexible light emitting layer and a TT layer over the flexible light emitting layer. In some examples, a flexible light emitting layer may comprise a flexible substrate and one or more light sources therein or thereon. For example, with reference to FIGS. 3A and 3B, the light emitting layer comprising the substrate 314 and the light sources 310 may correspond to a flexible light emitting layer. The flexible light emitting layer may comprise any now known or later developed light source(s) and substrate(s) capable of being flexed or bent into a desired position. In some examples, the flexible light emitting layer may be coupled flush to a TT layer. Flexible light emitting layers may comprise, for example, a flexible printed circuit board (PCB) comprising one or more discrete light sources thereon. The one or more discrete light sources may comprise LEDs. The one or more discrete light sources may comprise flexible LEDs. In some examples, a flexible light emitter may include an electroluminescent panel and/or an OLED layer. Flexible light emitting layer may include any number of emitters necessary to inactivate insects and create the desired color, intensity, irradiance, etc. In some examples, the device further may comprise a light-converting layer to convert another portion of the light to a wavelength different from the wavelength of the at least the portion of the light emitted from the flexible light emitting layer.

In some examples, light sources or a light emitting layer may be embedded in a TT layer. For example, the sources 310 or the light emitting layer, comprising the substrate 314 and the light sources 310, may be embedded within the body between the interior surface 324 and the exterior surface 322 of the TT layer 318.

An example light source for emitting light to inactivate insects may be configured to direct light into a body and out of an exterior surface of the body. The body may be, for example, a TT layer, or a protective layer over the light source. The light source may be configured to emit light through an edge of the body between interior and exterior surfaces. For example, with reference to the lighting device 300, light sources 326 may be positioned perpendicularly to the interior surface 324 of the TT layer 318 and the exterior surface 322 of the TT layer 318. The light sources 326 (e.g., LEDs) may be coupled to the TT layer 318 via a separate structure (e.g., a bracket) or may be integrated within the TT layer 318. Alternatively, the light sources 326 may be embedded within a body (e.g., within the TT layer 318). A cover (e.g., over a light source) may comprise waveguide(s) within the body for directing the light to an exterior surface of the body, and out as exiting light. Waveguide(s) may include any now known or later developed optical device for directing, confining or conveying light waves. For example, waveguide(s) may comprise fiber optic diffuser elements bonded within an exterior surface, and illuminated by lasers that provide illumination through the exterior surface. Edge lighting may be beneficial because fewer light emitters may be needed. Edge lighting may also be considered more aesthetically pleasing because individual light sources may be invisible from an exterior of a device, and only a uniform light may be seen.

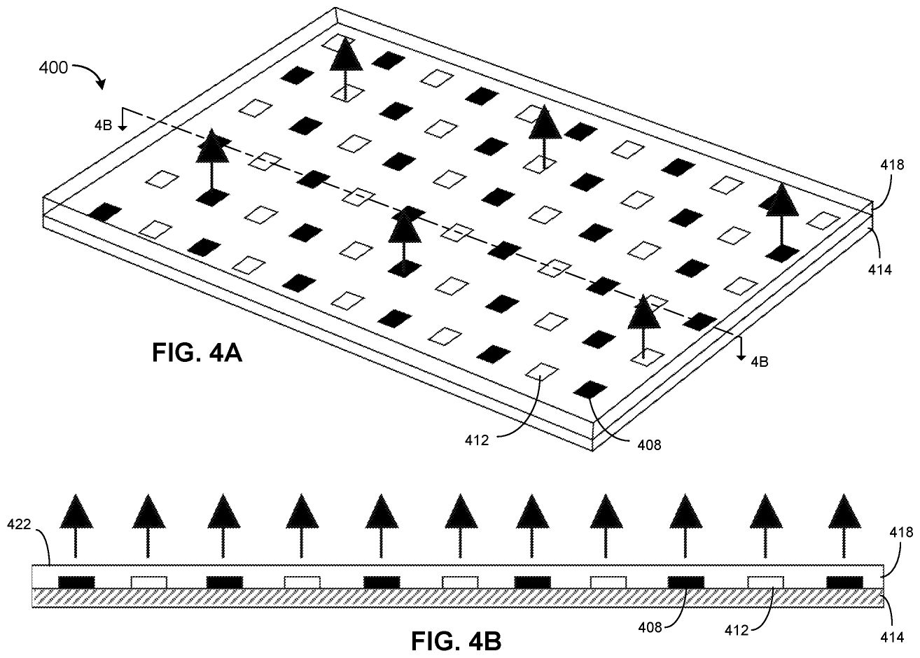

FIGS. 4A and 4B show an example device 400. The device 400 may be, for example, an internally illuminated mat and/or a cutting board, and may be similar to the device 300. Elements 414, 418, and 422 are similar to elements 314, 318, and 322, respectively, and are not discussed in detail for reasons of brevity. The device 400 may comprise light sources (e.g., LEDs, and/or any other light source) emitting different wavelengths of light. Light sources 408 may correspond to a light source that emits light at a wavelength range appropriate for inactivating insects (e.g., blue light), and light sources 412 may correspond to a light source that emits light at a wavelength range appropriate for disinfection (e.g., violet light). Emitted light may travel through the TT layer to illuminate an outer surface 422 and may cause inactivation of insects and/or disinfection of microorganisms.

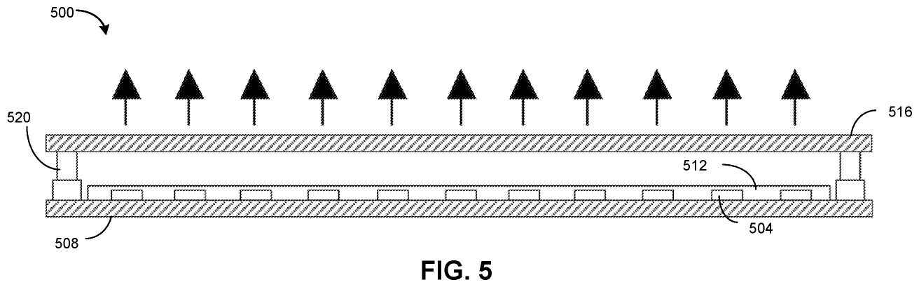

FIG. 5 shows a side view of an example lighting device to inactivate insects, in accordance with one or more examples disclosed herein. The example device 500 may be similar to the devices 300 and/or 400 except that the device 500 may comprise a detachable top layer over light sources. The layers may be detachable, for example, to allow for easier cleaning of each layer separately. The device 500 may be, for example, used as a cutting board.

The device 500 may comprise light sources 504. The device 500 may further comprise a substrate 508 and a TT layer 512 that is coupled to the substrate 508. The light sources 504 may be, for example, within the TT layer 512 or as may be in a separate layer beneath the TT layer 512. The light sources 512 may be, for example, attached to the substrate 508. The light sources 512 may be configured to emit light for inactivating insects and/or disinfection of microorganisms. The TT layer 512 may function as a protective layer for the light sources 504.

A top layer 516 may be configured to be attached to the substrate 508. The top layer 516 may be transparent or translucent. The top layer 516 may be consist a mechanism 520 for fastening the top layer 516 to the substrate 508. The top layer 516 may be fastened to the substrate using, for example, removable screws located at the corners of the top layer 516. Light (e.g., emitted by the light sources 504) may travel through the TT layer 512 and through the top layer 516 to illuminate an outer surface the top layer 516.

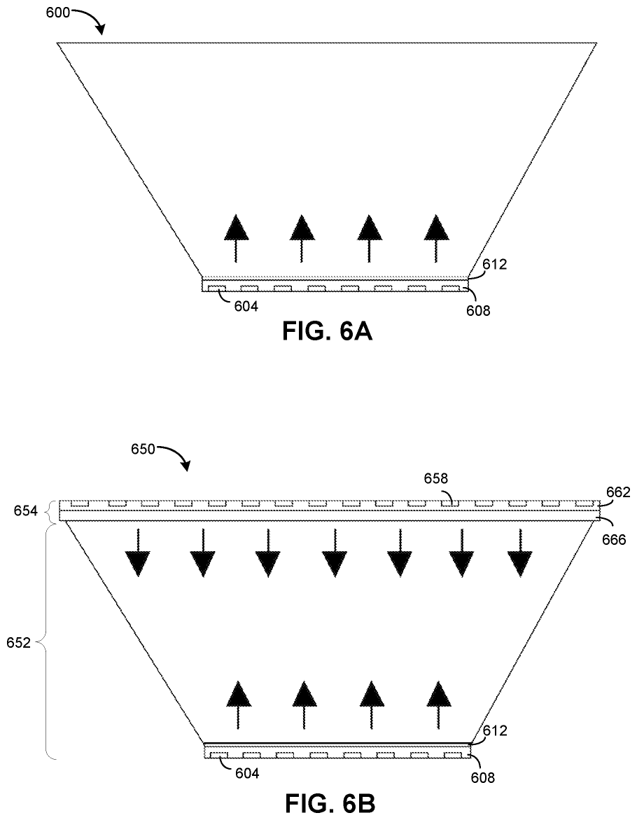

FIGS. 6A and 6B show example container devices (e.g., bowls) with integrated light sources to inactivate insects, in accordance with one or more examples disclosed herein. FIG. 6A shows a cross section of an example container 600. Light sources 604 may be positioned on a bottom surface of the container 600 and may be configured to emit light into the container 600. Light sources 604 may be configured to emit light for inactivating insects (e.g., blue light) and/or disinfection of microorganisms (e.g., violet light). The light sources 604 may comprise, for example, strip lighting elements and/or a PCB populated with LEDs. A TT layer 608 and/or a protective layer 612 may be positioned over the light sources 604. The protective layer 612 may be transparent and may comprise plastic, glass, rubber, and/or the like. Other methods of protection may be used such as conformal coatings over the lighting elements. The contents of the bowl may rest on the protective layer 612.

FIG. 6B shows a cross section of an example container 650. The container 650 may comprise a lower body 652 and a top cover 654. The lower body 652 may be similar to the container 600, and like-numbered elements are not discussed in detail for brevity. The top cover 654 may be configured to emit light for inactivating insects (e.g., blue light) and/or disinfection of microorganisms (e.g., violet light). The top cover 654 may be opened to access the inside of the lower body 652. The top cover 654 may comprise, light sources 658 that are configured to direct light into the lower body 652. The light sources 658 may be, for example, strip lighting elements and/or a PCB populated with LEDs. The top cover 654 may comprise TT layer 662 and/or a protective layer 666. The protective layer 666 may be similar to the protective layer 612. The top cover 654 may be configured to be completely separated from the rest of the lower body 652, or may be connected, via a hinge and/or a conduit, to the lower body 652. The conduit may comprise wiring that electrically connects the light sources 654 to a power source that may be placed in the lower body 652, or to an external power source (e.g., an electrical outlet).

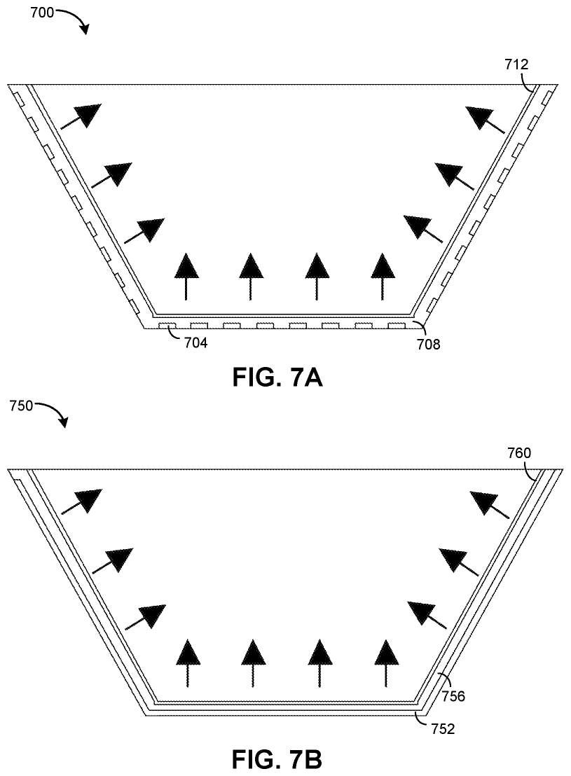

FIGS. 7A and 7B show example container devices with integrated light sources to inactivate insects, in accordance with one or more examples disclosed herein. FIG. 7A shows a cross section of an example container 700. The container 700 may comprise light sources 704. The light sources 704 may be used to provide inactivating light (e.g., blue light) and/or disinfecting light (e.g., violet light). A TT layer 708 and/or a protective layer 712 may be disposed over the light sources 704. The protective layer 712 may be similar to the protective layer 612. The container 700 may be similar to the container 600, except the light sources 704 are also disposed in side walls of the container 700.

FIG. 7B shows a cross section of an example container 750. The container 750 may be similar to the container 700, except lighting may be provided using uniform light sources 752. The uniform light sources 752 may comprise, for example, flexible OLED panels. The container 750 may comprise a TT layer 756 and/or a protective lower 760. The protective layer 760 may be similar to the protective layer 612.

A light source and/or a light emitting layer may be controlled (e.g., using multiple different light sources) to emit a variety of other different wavelengths and colors, with at least a portion of a spectrum of emitted light within a wavelength range of 420 nm-510 nm. In some examples, color/intensity of emitted light may be controlled to match a color of a structure to which a lighting device may be attached. Color temperature of output light may be customized by using light sources corresponding to different wavelengths. For example, LEDs corresponding to different wavelengths (e.g., blue LED, green LED, red LED, and/or the like may be used, for example in the lighting devices 200, 220, 300, 400, and/or any other lighting devices described herein) and the intensity ratio of the different wavelengths may be adjusted. To obtain a warmer color temperature, blue light intensity may be reduced. To obtain a cooler color temperature (e.g., for use in a commercial setting), blue light intensity may be increased. Blue light may stimulate melatonin suppression. Accordingly, a lighting device may use less blue light at night. In various examples described herein, more blue light may be supplied in daytime and less blue light may supplied at night.

Exposure to blue light may cause eye strain on users of the light emitting devices disclosed herein. This may be referred to as blue-light hazard. Various examples described herein may use different techniques to avoid eye strain associated with blue-light hazard. Blue-light hazard may be most severe for 440 nm light, and exposure limits for other wavelengths may be characterized in relation to the 440 nm light. For example, 440 nm light may be weighted at 1.0 on a blue light hazard weighting function, whereas 467 nm light may be weighted at approximately 0.67. Exposure time limits, corresponding to different radiances, to prevent blue-light hazard are shown in Table 3. Control systems may be used to prevent prolonged exposure to wavelengths that are harmful to the human eye and may be designed based on exposure time limits and/or appropriate weights of the blue light hazard weighting function. Inactivating light sources may be contained in enclosures to reduce risk to the human eye (e.g., due to blue-light hazard).

TABLE 4
Exposure time limits to prevent blue-light hazard.

| | Radiance | |
|---|---|---|
| | Limit | Exposure |
| Category | (W/m²sr) | Time Max (s) |
| Exempt | 100 | 10⁴ |
| Low Risk | 10000 | 10² |
| Moderate Risk | 4000000 | 2.5 |

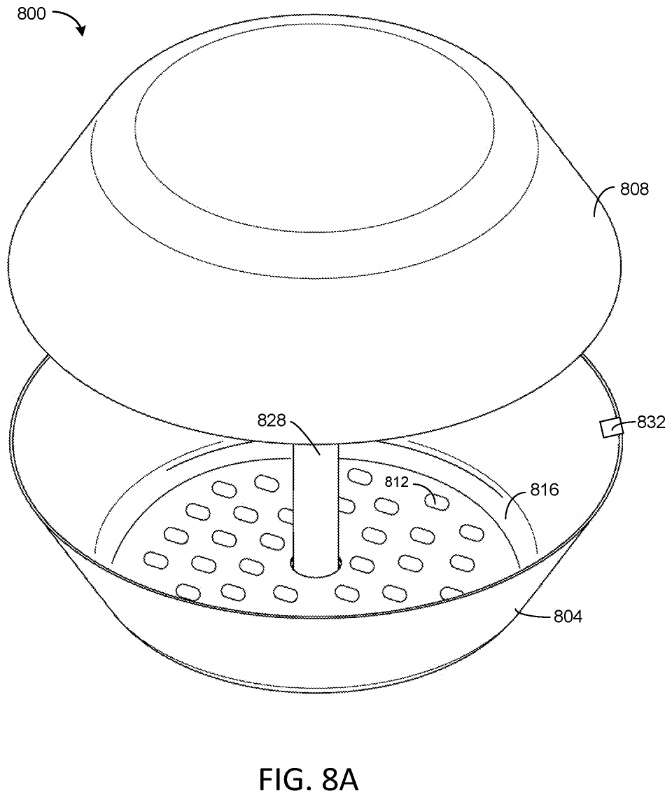

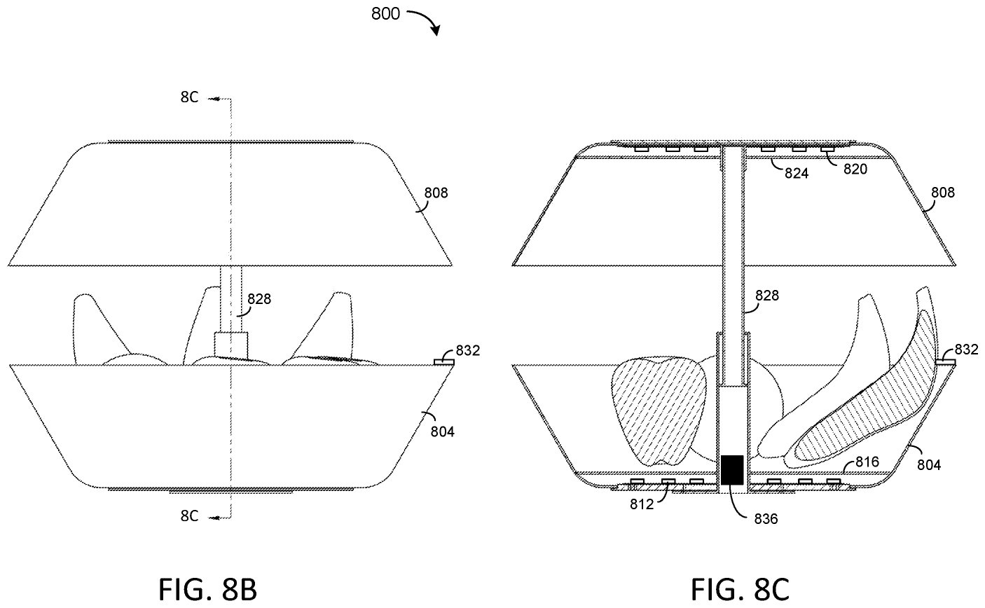

FIGS. 8A-8C show an example bowl-shaped container device with integrated light sources to inactivate insects, in accordance with one or more examples disclosed herein. FIG. 8A shows an example bowl 800 that may be used for food storage. FIGS. 8B and 8C show the side view and cross section view of the bowl 800, respectively. The bowl 800 may comprise a lower body 804 and a top cover 808. The lower body 804 may comprise light sources 812 configured to direct light into the bowl 800. A protective layer/panel 816 may be disposed over the light sources 812. The top cover 808 may comprise light sources 820 configured to direct light into the bowl 800. Light sources 812 and 820 may be configured to emit light for inactivating insects (e.g., blue light) and/or disinfection of microorganisms (e.g., violet light). Transparent/translucent protective layers/panels 816 and 824 may cover the light sources 812 and 820, respectively. The protective layers/panels 816 and 824 may be, for example, manufactured from plastic, glass, rubber, and/or the like. In some examples, one or more conformal coatings of various materials may be used as protective layers over the light sources 812 and/or 820. The top cover 808 may be opened to access the interior of the bowl 800. The bowl 800 may be configured to contain the light within itself such that blue light does not flood the surrounding space and cause discomfort to the eye. The outer surface of the bowl 800, for example, may be manufactured from an opaque material.

The light sources 812 and 820 may be configured to emit light for inactivating insects and/or disinfection of microorganisms. The light sources 812 and 820 may be, for example, strip lighting devices and/or PCB(s) populated with LEDs. The top cover 808 may be connected, via a conduit 828, to the lower body 804. The conduit 828 may comprise wiring that electrically connects the light sources 820 to a power source that may be placed in the lower body 804 or to an external power source (e.g., an electrical outlet). The top cover 808 may be configured to not be completely separable from the lower body 804, thereby making the wiring of the light sources 820 easier. For example, the light sources 820 may be wired through the conduit 828. The conduit 828 may be configured to allow the top cover 808 to be lifted away from the lower body 804 (to allow access to interior of the bowl 800) while still being attached to the lower body 804.

To avoid eye strain associated with blue-light hazard, a control system may be integrated with the bowl 800. The control system may implement lighting controls (e.g., to reduce blue-light hazard, user discomfort) based on a determination, by a sensor, of a user interaction with the bowl and/or user presence near the bowl. The control system may comprise a controller 836 (e.g., a microcontroller) that is in communication with a sensor 832, the light sources 812 and/or 820, and a power source powering the light sources 812 and/or 820. For example, one or more sensor(s) (e.g., the sensor 832 and/or other sensor(s)) may be used to determine a touch of a user, heat of a user's hand (e.g., on a container/enclosure), motion of a user, motion of the bowl 800, temperature corresponding to an environment in the proximity of the bowl, light reception on a surface (e.g., on the outside of the lower cover 804 and/or the top cover 808), etc. The controller 836 may activate/deactivate inactivating light sources (e.g., the light sources 812 and/or 820), control intensity of an inactivating light and/or control color of the inactivating light, etc., based on a determined user interaction/presence of a user. In an example, the bowl 800 may comprise other light source(s) that are not configured to emit blue light for insect inactivation (e.g., light source(s) operating at wavelengths that are not known to cause blue light hazard). The controller 836 may deactivate the light sources 812 and/or 820 and activate the other light source(s), for example, if the control system determines a presence of a user in the environment. Deactivation of the light source(s) 812 and/or 820 and activation of the other light source(s) may reduce user discomfort.

The control system may be configured to adjust an intensity of the light sources 812 and/or 820, for example, in response to an opening/closing of the top cover 808. The sensor 832 may be a switch or a motion sensor and may be used to detect opening/closing of the top cover 808. The sensor 832 may be attached to the lower body 804 or the top cover 808. The sensor 832 may be a push button, located on the inside of the top cover 808, or on an edge of the lower body 804 that is facing the top cover 808. The controller 836 may detect, using the sensor 832, that the top cover 808 is open. Based on the detection, the controller may lower the intensity, or deactivate the light sources 812 and/or 820. The controller 836 may detect, using the sensor 832, that the top cover 808 is open. Based on the detection, the controller 836 may lower the intensity, or deactivate the light sources 812 and/or 820.

A control system may be devised without using a microcontroller. An example control system may comprise a circuit comprising the sensor 832 (e.g., a push button), the light sources 812 and/or 820, and a power source powering the light sources 812 and/or 820. The push button may open or close the circuit. The push button may be depressed when the top cover 808 is closed over the bottom portion 804, thereby closing the circuit and activating the light sources 812 and/or 820. The push button may return to an un-pushed state when the top cover 808 is lifted, thereby opening the circuit and deactivating the light sources 812 and/or 820.

A control system (e.g., the control system corresponding to the bowl 800) may, for example, shut off inactivating light, lower inactivating light intensity, and/or switch to a different light wavelength (e.g., switch to a disinfecting light at 405 nm wavelength) based on one or more criteria. The control system may execute one or more lighting controls, for example, based on detection of usage of a device by a user, wavelengths associated with the blue light hazard, and intensities of the wavelengths associated with the blue-light hazard. The wavelengths and intensities may be determined using one or more sensors (e.g., the sensor 832 or any other sensor(s)). The control system may execute one or more lighting controls, for example, further based on a determination that an exposure time for the determined wavelengths is approaching or has exceeded a blue-light hazard exposure limit corresponding to the determined wavelengths and intensity.

In various lighting devices described herein, a motion sensor (e.g., the sensor 832) may be used to determine, for example, presence of a user (e.g., in a proximity of an environment/device subject to inactivating light). The control system may, based on a determination of the user, deactivate/reduce an intensity of the inactivating light, activate/increase an intensity of a white light, and/or change light color, etc., to reduce user discomfort and/or blue-light hazard that may be associated with the inactivating light. In some examples, the control system may implement lighting controls based on whether a device is being accessed by a user, based on a motion sensor. The motion sensor may comprise, for example, a switch mechanism that detects whether a container is open or close. For example, a food enclosure or a garbage can with an inactivating light may include a mechanism that automatically initiates one or more lighting controls if the food enclosure or the garbage can is opened. A control system in one or more methods, devices, and systems may use a combination of one or more of the above techniques to initiate lighting control(s).

Food enclosures or garbage cans may naturally attract insects into them because of their odor and because produce with eggs, larvae, or pupae on them are often stored with a food enclosure or disposed of in a garbage can. Blue lighting using one of the wavelengths or wavelength ranges stated above may be integrated into a garbage can using a number of different methods. Blue light may be provided by LEDs, lasers, electroluminescence, OLEDs, or any other method of producing blue light. LED strip lighting may be used within the garbage can or a PCB populated with blue LEDs may be mounted within the garbage can. The light may be directed from many angles from within the garbage can. In an example, light source(s) may be positioned throughout the interior of the garbage can and may be directed towards the center of the garbage can (at the bag). A clear garbage bag may be used to allow a higher proportion of light into the waste contents. In some examples, light source(s) may be attached to the inside of the garbage can cover.

A protective layer may be integrated with the light emitting devices used in environments that may be subject to exposure to wet environments, such as garbage cans. The protective layer may be a transparent layer comprising plastic, glass, rubber, etc. The protective layer may protect the light emitting devices from any splashing, residue, and/or condensation that may be associated with the contents of the garbage can. Other methods of protection may be used such as conformal coatings over the light sources.

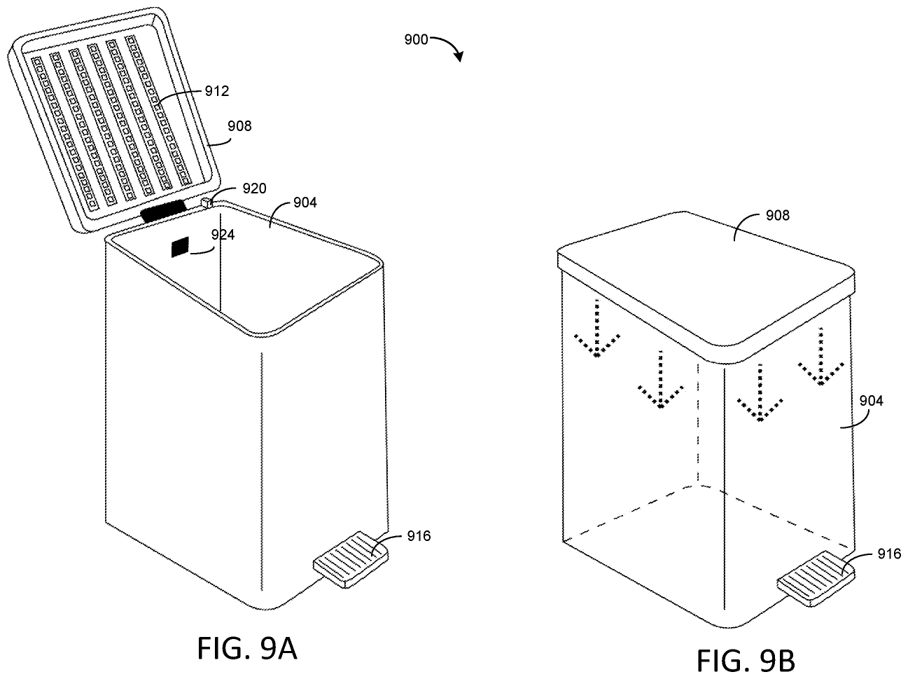

FIGS. 9A and 9B show an example garbage can 900 with light sources, integrated on a lid, to inactivate insects, in accordance with one or more examples disclosed herein. The garbage can 900 comprises a receptacle 904, a lid 908, light sources 912, and a foot pedal 916. The foot pedal 916 may be used to open or close the lid 908. The light sources 908 may be located on the inside of the lid 908 and may be configured to emit light for inactivating insects (e.g., blue light) and/or disinfection of microorganisms (e.g., violet light). Operation of the light sources 908 may be controlled by a sensor 920 (e.g., a switch) that detects opening or closing of the lid 908. Other sensors such as motion sensors, light beam sensors, magnetic proximity sensors, capacitive touch sensors, etc., may be used to detect opening/closing of the lid of the garbage can. Some garbage cans may have a voice activated control that opens/closes the lid.

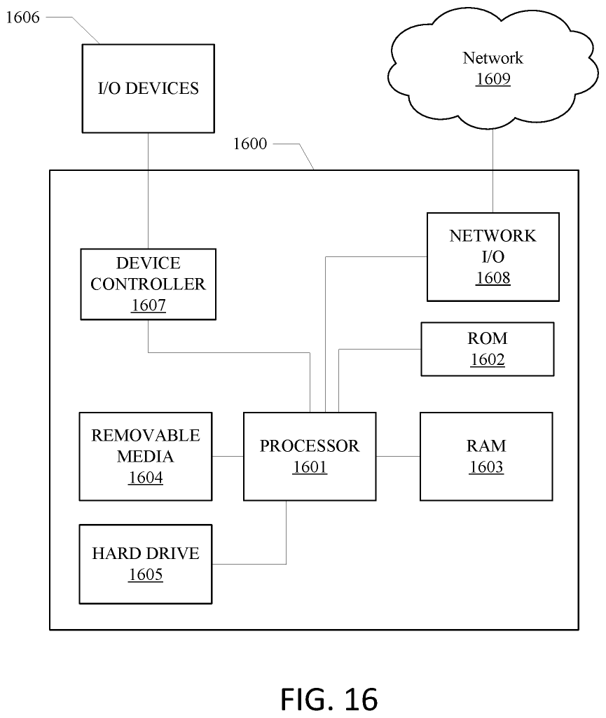

A control system (e.g., a controller 924 in communication with the sensor 920 and the light sources 920) may be used to control or adjust an intensity of the blue light to prevent uncomfortable exposure to the blue light when the lid 908 is opened. For example, the controller 924 may be configured to increase an intensity (or turn on) the blue light in response to detecting (using the sensor 920) closing of the lid 908, and decrease an intensity (or turn off) the blue light in response to opening of the lid 908. In some examples, the control system may be integrated with voice control to adjust the intensity of the blue light. The example garbage can 900 may further include additional components such as a power supply, light driver, control system circuitry, and/or the like, placed within the garbage can. An example control system that may be used with the garbage can 900 (or any other lighting device described herein) is further explained with reference to FIG. 16. FIG. 9B shows an example operation of the garbage can 900 with light sources 912 directing light into the receptacle 904 when the lid 908 is closed.

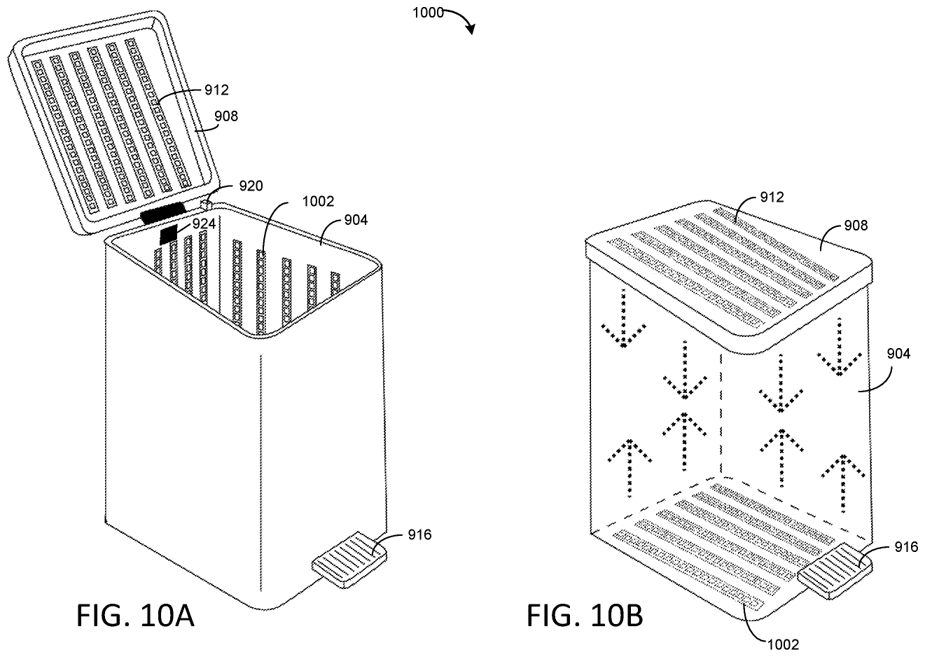

FIGS. 10A and 10B shows an example garbage can 1000 with light sources, integrated on a lid and in a lower receptacle, to inactivate insects, in accordance with one or more examples disclosed herein. The garbage can 1000 may be similar to the garbage can 900, except that the garbage can 1000 may have additional light sources 1002 on the side walls and/or on the bottom surface of the receptacle 904. Like-numbered elements are not discussed in detail for brevity. The light sources 912 and 1002 direct light into the receptacle 904. FIG. 10B shows an example operation of the garbage can 1000 with light sources 912 and 1002 directing light into the receptacle 904 when the lid 908 is closed.

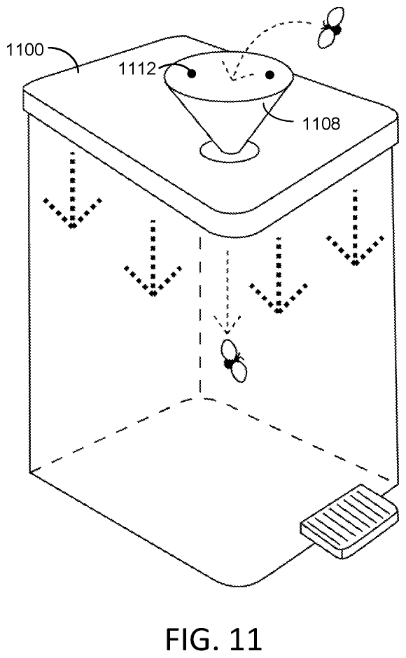

A trap mechanism may be integrated with various devices described herein. FIG. 11 shows an example garbage can 1100 with an insect trapping mechanism and light sources to inactivate insects, in accordance with one or more examples disclosed herein. The garbage can 1100 may be similar to the garbage cans 900 or 1000, except that a funnel-shaped trap device 1108 may be integrated with the garbage can 1100. The trap device 1108 may be a funnel that allows the insects to travel into a container (e.g., a garbage can) from the outside but not crawl back out.

Insects are likely to be naturally attracted into the garbage can 1100 due to odor, but attractant lighting may also be used to lure the insects into the garbage can. Insects are often attracted by near ultra violet (UV) or UV lighting. 405 nm lighting, as used for disinfection, may be in the near-UV range and may double as a disinfectant and attractant. UV lighting in a wavelength range of 100 nm-380 nm may also be used as a disinfectant and attractant. The trap device 1108 may comprise UV and/or near-UV light sources 1112 that may attract insects from the periphery of the garbage can 1100. A fan (not shown) may be located on the inside of the funnel. The fan may suck in the insects attracted by the light sources 1112 into the garbage can 1100 and prevent escape. In some examples, sticky paper may be used to prevent escape.

Disinfecting UV lighting may be applicable in garbage cans (e.g., the garbage cans 900, 1000, and/or 1100) to help reduce odor due to bacteria, mold, and fungi. For example, the light sources 912 and/or 1002 may be configured to emit UV light in addition to insect inactivating light. Similar to blue light, UV and near-UV light may be also associated with hazards. Accordingly, any UV or near UV lighting may be controlled (e.g., turned off, operated at a reduced intensity, etc.) based on detection of an opening of a container opening, measurements by a motion sensor, and/or any other input. The controller 924 and the sensor 920, for example, may be used to control UV light. The controller 924 may be configured to reduce an intensity of UV light for example, in response to detecting, using the sensor 920, opening/closing of the lid 908.

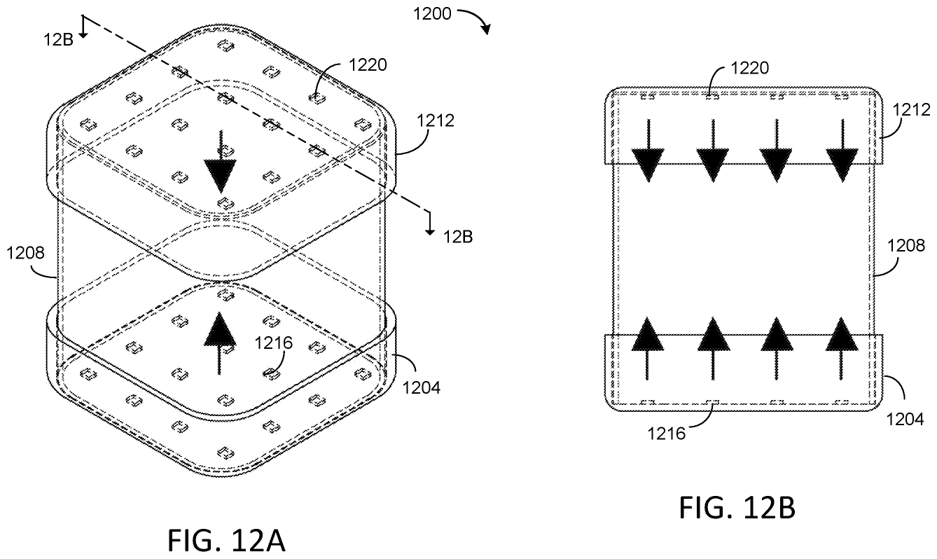

FIGS. 12A and 12B show an example container 1200 with integrated light sources to inactivate insects, in accordance with one or more examples disclosed herein. The container 1200 that may be used as food storage container. The container 1200 may comprise light emitting sources 1220 on a removable lid 1212, and light emitting sources 1216 on the base 1204. The lid 1212 and the base 1204 enclose the body 1208 of device 1200. The light emitting sources 1220 and 1216 may be configured to emit blue light for insect inactivation and/or disinfecting light. The container 1200 may be transparent or translucent to allow its contents to be visible from outside.

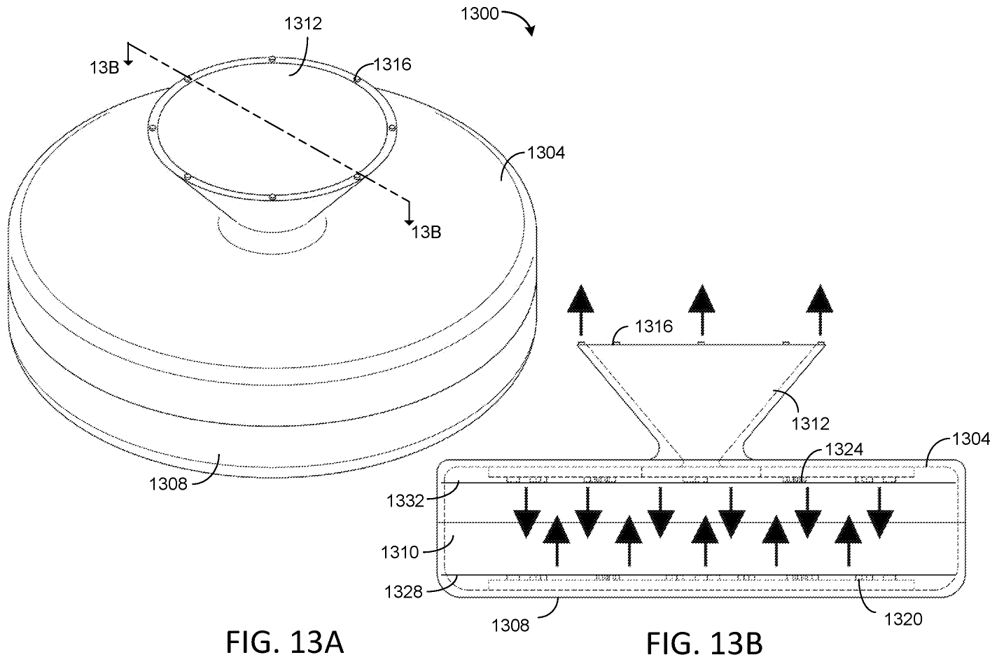

FIGS. 13A and 13B show an example insect trapping device 1300 with integrated light sources for luring, trapping, and inactivation of insects, in accordance with one or more examples disclosed herein. The device 1300 may comprise a top half 1304 and a bottom half 1308 enclosing an internal cavity 1310. Blue light emitting sources 1324 and 1320 may be attached to the top half 1304 and bottom half 1308, respectively. Transparent protective layers 1332 and 1328 may be used to cover the light emitting sources 1324 and 1320, respectively. A funnel-shaped trap 1108 may be integrated with the top half 1324. The trap 1108 may open into the cavity 1310. UV light sources 1316 may attract insects from the periphery. A fan (not shown) may be located on the inside of the funnel or in the cavity 1310. The fan may be used to suck in any insects that are attracted by the UV light sources 1316 and prevent escape. In some examples, sticky paper may be used to prevent escape.

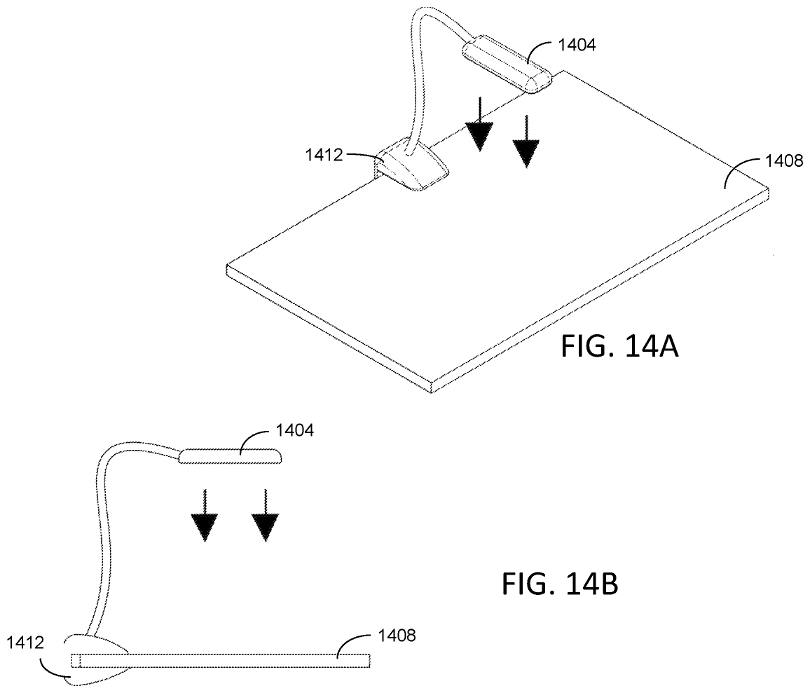

FIGS. 14A and 14B show an example task lighting device affixed onto a surface, in accordance with one or more examples disclosed herein. The lighting device may comprise a light source 1404 that is affixed using an anchor 1412 to a surface 1408 (e.g., a table top). The light source 1404 may comprise, for example, LEDs, that emit blue light to inactivate insects.

Various containers (e.g., food containers, garbage cans, or the like) that do not include built-in inactivating lighting mechanisms may be retrofitted to provide inactivating light. In some examples, retrofit kits may be devised for currently available designs of garbage cans. The retrofit kit may comprise light sources, power supplies, control systems and/or the like configured to provide inactivating blue light and/or disinfecting violet light. The retrofit kit may include, for example, a device with lighting elements that may be placed at varying locations on the interior of the garbage can, such as the inside of the lid, bottom, or sides. The retrofit kit may include adhesives (e.g., tapes) or attachment mechanisms (e.g., clips) to affix the light sources. The retrofit may also include trapping mechanisms, such as a funnel, that may be fastened to the garbage can at varying locations, such as on a side of a lid.

In some examples, one or more of devices described herein may use a combination of mechanisms for insect trapping mechanisms such as electrocution, funneling, attractant light, sticky paper, insecticides and/or the like to increase device efficacy. The mechanisms may be used, for example, in combination with blue light and/or violet light.

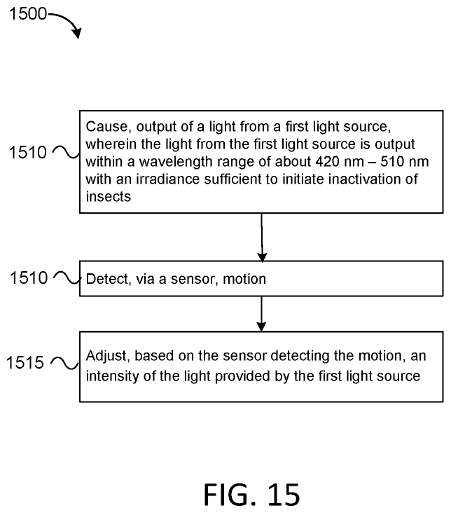

FIG. 15 shows an example method 1500 for generation of light to inactivate insects, in accordance with one or more examples disclosed herein. Any of lighting devices as described with reference to FIGS. 2-14 may be used to implement the method 1500. In other examples, a lighting device different from lighting devices described above may be used to implement the method 1500. At step 1505, a light source, may output light within a wavelength range of about 420 nm-510 nm with an irradiance sufficient to initiate inactivation of insects. At step 1510, a sensor may detect a motion. The motion may correspond to movement of a portion of a device that comprising the light source. At step 1515, based on the sensor detecting the motion, an intensity of the light from the first light source may be adjusted.

FIG. 16 illustrates an example computing device 1600 (e.g., a controller), that may perform the method 1500, the functions of various control systems described herein, and/or any other computer, controller, or processor-based function described herein. The computing device 1600 may implement, for example, a control system for control of various lighting parameters, as described herein. In some examples, the computing device 1600, in communication with one or more sensors and one or more lighting devices may implement lighting controls based on sensor measurements. In some examples, the computing device 1600 may be a microcontroller configured to implement the functions of various control systems described herein.

The computing device 1600 may include one or more processors 1601, which may execute instructions of a computer program to perform any of the features described herein. The instructions may be stored in any type of tangible computer-readable medium or memory, to configure the operation of the processor 201. As used herein, the term tangible computer-readable storage medium is expressly defined to include storage devices or storage discs and to exclude transmission media and propagating signals. For example, instructions may be stored in a read-only memory (ROM) 1602, random access memory (RAM) 1603, removable media 1604, such as a Universal Serial Bus (USB) drive, compact disk (CD) or digital versatile disk (DVD), floppy disk drive, or any other desired electronic storage medium. Instructions may also be stored in an attached (or internal) hard drive 1605. The computing device 1600 may include one or more input/output devices 1606, such as one or more sensors, lighting devices, display, touch screen, keyboard, mouse, microphone, software user interface, etc. The computing device 1600 may include one or more device controllers 1607 such as a video processor, keyboard controller, etc. The computing device 1600 may also include one or more network interfaces 1608, such as input/output circuits (such as a network card) to communicate with a network such as example network 1609. The network interface 1608 may be a wired interface, wireless interface, or a combination thereof. One or more of the elements described above may be removed, rearranged, or supplemented without departing from the scope of the present disclosure.

Various methods, devices, and systems described herein may use a control system (e.g., a control system described with reference to FIG. 16) to implement various lighting controls. The control system may be used to control/adjust various aspects of emitted light (e.g., an intensity of inactivating light, irradiance of the inactivating light, a wavelength of the inactivating light, a color of the inactivating light, a duration of exposure to the inactivating light, activation/deactivation of an inactivating light source, etc.). In various examples, the control system may be used to control similar parameters corresponding to other wavelengths of light as well. The other wavelengths of light may correspond to white light, ultraviolet (UV) light, and/or other wavelengths that are not configured to inactivate insects. In various examples, the control system may be used to control various aspects of emitted light (e.g., insect inactivating light) in order to reduce and/or limit blue light hazard.

Input/output devices (e.g., the input/output devices 1606) may comprise light source(s) configured to provide light at wavelengths appropriate to inactivate insects (e.g., blue light) and or to disinfect (e.g., violet light). Sensor(s) may be used to determine one or more parameters corresponding to an environment subject to inactivating light and/or disinfecting light. Input/output devices (e.g., the input/output devices 1606) may comprise, for example, one or more of irradiance sensors, radiant intensity sensors, motion sensors, sound sensors, odor sensors, fluorescence sensors, thermal sensors, capacitive touch sensors, light beam sensors, magnetic proximity sensors, and/or any other sensors. The computing device may control an output of the light source(s) based on one or more measurements determined using the one or more sensors.

The control system may use, for example, sensor(s) to determine if an enclosure, subject to the inactivating light, is open, a number of times the enclosure is opened, and/or a duration of time for which the enclosure is opened, etc., to implement lighting controls. The control system may use, sensors to determine a quantity of items (e.g., number, weight, etc.) on a surface/in an enclosure, subject to inactivating light, to implement lighting controls. The control system may control lighting to be continuous or intermittent based one or more of parameters as measured by sensors, and/or based on a preprogrammed user setting. The control system may implement lighting controls based on a time of the day. For example, more blue light may be supplied during daytime and less blue light may supplied during nighttime. The control system may use a combination of one or more of the above sensors, parameters, and/or other sensors described herein to implement lighting controls.

In some examples, the one or more sensors may be used to measure irradiance at certain locations exposed to the inactivating light (e.g., at midpoints of containers, surfaces). A control system may vary various parameters of inactivating light (or other wavelengths of light), as emitted by one or more light sources, based on measurements provided by the one or more sensors. The control system may implement lighting controls, for example, to maintain a achieve a required level of insect inactivation and/or limit blue light hazard.

In some examples, one or more sensors may be used to detect a weight/quantity of items in a container or on a surface, and implement lighting controls based on a determination of the weight. A control system may, for example, adjust the intensity and/or duration of inactivating light in proportion to a weight of items.

In some examples, one or more of motion sensor(s), sound sensor(s), odor sensor(s), and/or fluorescence sensor(s), etc., may be used to determine presence of insects and/or a level of insect infestation in an environment that is subject to inactivating light. A motion sensor may be positioned, for example, within a space illuminated by inactivating light. The control system may, for example, turn on an inactivating light, and/or increase an intensity/duration of the inactivating light based on determination of motion (e.g., using the motion sensor). The control system may adjust (e.g., increase) the intensity and/or duration of inactivating light in proportion to a determined infestation level.

In some examples, sensor(s) may use thermal sensors, touch sensors, motion sensors, and/or light sensors to detect user presence/interaction with an environment that is subject to inactivating light. A sensor may detect, for example, a user touching a door to an enclosure (e.g., a door of refrigerator, an oven, etc.). The control system may increase/decrease an intensity of inactivating light, or turn on inactivating light, in the enclosure based on detected human interaction. The control system may decrease an intensity of inactivating light, for example, if a user is touching the door, but may increase the intensity based on detecting that the user is not touching the door. The control system may decrease an intensity of inactivating light, for example, to reduce user exposure to blue light and reduce the effects of the blue-light hazard. The control system may additionally increase an intensity of non-inactivating light (e.g., visible light at wavelengths not known to cause inactivation of insects), in response to detecting user presence/interaction.

Modifications may be made as desired, to the above discussed examples, for different implementations. For example, steps and/or components may be subdivided, combined, rearranged, removed, and/or augmented; performed on a single device or a plurality of devices; performed in parallel, in series; or any combination thereof. Additional features may be added.

What is claimed is:

1. A device comprising
a body;
a first light source disposed within the body and operable to provide light comprising a wavelength in a range of about 420 nm-510 nm and comprising an irradiance sufficient to initiate inactivation of insects;
a sensor operable to detect motion; and
a controller in communication with the first light source and the sensor and configured to adjust, based on the sensor detecting motion, an intensity of the light provided by the first light source.

2. The device of claim 1, wherein the motion detected by the sensor comprises movement of an insect, and wherein the controller adjusts the intensity of the light provided by the first light source by increasing the intensity.

3. The device of claim 1, wherein the motion detected by the sensor comprises movement of at least a portion of the device, and wherein the controller adjusts the intensity of the light provided by the first light source by decreasing the intensity.

4. The device of claim 3, further comprising a second light source, wherein the controller is configured to increase, based on the sensor detecting the motion, the intensity of the light provided by the second light source.

5. The device of claim 1, wherein the wavelength comprises one of 440 nm, 456 nm, 467 nm, 496 nm, or 508 nm.

6. The device of claim 1, further comprising a sensor operable to detect at least one of: sound, odor, fluorescence, a weight of objects placed on the device, or a weight of objects placed within the device.

7. The device of claim 1, wherein the controller is configured to adjust at least one of: the intensity of the light provided by the first light source, a wavelength of the light provided by the first light source, a color of the light provided by the first light source, or a duration of exposure of the light provided by the first light source.

8. The device of claim 1, further comprising a sensor operable to determine irradiance on a surface of the body exposed to the light from the first light source, wherein the controller is configured to adjust, based on the irradiance, the intensity of the light from the first light source.

9. The device of claim 1, the light source is further operable to provide light comprising a wavelength in a range of about 380 nm-420 nm.

10. A method for inactivation of insects in an enclosure, the method comprising:
causing output of a light from a first light source, wherein the light from the first light source comprises a wavelength in a range of about 420 nm-510 nm and comprises an irradiance sufficient to initiate inactivation of insects;
detecting, via a sensor, motion; and
adjusting, based on the sensor detecting motion, an intensity of the light from the first light source.

11. The method of claim 10, wherein the motion detected by the sensor comprises movement of an insect, and wherein the adjusting the intensity of the light from the first light source comprises increasing the intensity of the light.

12. The method of claim 10, wherein the motion detected by the sensor comprises movement of at least a portion of the enclosure, and wherein the adjusting the intensity of the light from the first light source comprises decreasing the intensity of the light.

13. The method of claim 12, further comprising increasing an intensity of light from a second light source.

14. The method of claim 10, wherein the wavelength comprises one of 440 nm, 456 nm, 467 nm, 496 nm, or 508 nm.

15. The method of claim 10, further comprising:
determining, using an irradiance sensor, irradiance on a surface that is exposed to the light from the first light source; and
adjusting, based on the irradiance, the intensity of the light from the first light source.

16. A system for inactivation of insects in an enclosure, the system comprising:
a first light source operable to provide light comprising a wavelength in a range of about 420 nm-510 nm and comprising an irradiance sufficient to initiate inactivation of insects;
a sensor operable to detect motion; and
a controller, in communication with the first light source and the sensor, configured to adjust, based on the sensor detecting motion, an intensity of the light provided by the first light source.

17. The system of claim 16, wherein the motion detected by the sensor comprises movement of an insect, and wherein the controller adjusts the intensity of the light provided by the first light source by increasing the intensity.

18. The system of claim 16, wherein the motion detected by the sensor comprises movement of at least a portion of the enclosure, and wherein the controller adjusts the intensity of the light provided by the first light source by decreasing the intensity.

19. The system of claim 16, further comprising a second light source, wherein the controller is configured to increase, based on the sensor detecting the motion, an intensity of light provided by the second light source.

20. The system of claim 16, wherein the wavelength comprises one of 440 nm, 456 nm, 467 nm, 496 nm, or 508 nm.
